(19) United States
(12) Patent Application Publication
(10) Pub. No.: US 2006/0056611 A1
(43) Pub. Date: Mar. 16, 2006

(54) Selective outgoing call barring

(76) Inventors: Rory Joseph Donnelly, Surrey (GB); Paula Jane Donnelly, Surrey (GB)

Correspondence Address: MILLS & ONELLO LLP, ELEVEN BEACON STREET, SUITE 605, BOSTON, MA, 02108, US

(21) Appl. No.: 10/516,433

(22) PCT Filed: May 29, 2003
(86) PCT No.: PCT/GB03/02351

§ 371 Date: Nov. 30, 2004

(30) Foreign Application Priority Data
Jun. 1, 2002 (GB) 0212833.8
Sep. 20, 2002 (GB) 0221934.3
Jan. 7, 2003 (GB) 0300289.6

(51) Int. Cl. H04M 1/66

(52) U.S. Cl. 379/200; 379/199

(57) ABSTRACT

The security device comprises (i) a first connector (12) for connection to a telecommunications device (14; 15) such as a land-line telephone, mobile telephone or the modem of a computer, (ii) a second connector (16) connected to a telecommunications line (18), and (iii) a normally closed switch (20, 21) having a closed position in which a signal pathway (22, 23) within the security device between the first connector (12) and the second connector (16) is enabled and an open position in which the signal pathway (22, 23) is interrupted. A control device (24, 25) for controls the position of the switch (20, 21). A programmable memory (26, 27) stores allowed signal sequences and at least one authorised pass number. A comparator (30) is in operative connection with the control device (24, 25) and compares signals on the pathway (22, 23) with the allowed stored signal sequences. The control device (24, 25) opens the switch (20, 21) when a signal on the pathway (22, 23) does not match one of the stored signal sequences. A programmer (32) receives pass numbers and programming signals from a remote telecommunications device (52) via the telecommunications line (18). The programmer (32) includes an authorised pass number recognition device (34) for comparing a received pass number with the authorised pass numbers stored in the memory (26,27). The memory (26, 27) can be reprogrammed only when an authorised pass number is received.

### FIELD OF THE INVENTION

The present invention relates to a telecommunications security device, in particular to such a security device which enables an authorised person to control the use of telecommunication equipment by others, such as to barr the use of a telephone from making outgoing calls to unauthorised numbers and as an Internet connection limiting device.

### BACKGROUND OF THE INVENTION

Systems are known for controlling the use of telephone equipment by barring outgoing calls to certain prescribed numbers, such as international numbers, premium rate numbers or numbers outside the local area. While such systems have their uses, it is necessary for the person programming such a system to anticipate all the numbers which he considers to be unauthorised. For an employer who does not have minute by minute sight of his staff, there may be a need to prevent employees from making personal calls without authority.

We are aware of U.S. Pat. No. 5,802,157 (Clarke et al.) which describes a service for screening outgoing telephone calls. The service allows a subscriber to determine the times of day and/or days of the week when she wants her outgoing calls on her telephone line to be restricted to numbers which have been approved by her. Calls to numbers other than those on the authorised list will not be completed.

We are also aware of International patent application WO87/00376 (Newell) which describes a telephone line access control for preventing unauthorised outgoing calls on a telephone line. Dialling signals on the line are monitored, the monitored signals are encoded, and the encoded signals are compared with a memorised authorisation code. Control circuitry temporarily interrupts the line connection when the encoded signals do not match the authorisation code.

### SUMMARY OF THE INVENTION

According to a first aspect of the invention there is provided a telecommunications security device comprising:

(i) a first connector for connection to a telecommunications device,

(ii) a second connector for connection to a telecommunications line,

(iii) a switch having a normally closed position in which a signal pathway within the security device between the first connector and the second connector is enabled and an open position in which the signal pathway is interrupted,

(iv) a control device for controlling the position of the switch,

(v) a programmable memory for storing allowed signal sequences and at least one authorised pass number,

(vi) a comparator in operative connection with the control device for comparing signals on the pathway with the allowed stored signal sequences, the control device being adapted to open the switch when a signal on the pathway does not match one of the stored signal sequences, and P (vii) a programmer adapted to receive pass numbers and programming signals from a remote telecommunications device via a telecommunications line connected to the second connector, the programmer including an authorised pass number recognition device for comparing a received pass number with the authorised pass numbers stored in the memory, and being adapted to program the memory only when an authorised pass number is received.

According to a second aspect of the invention, there is provided a method of controlling a telecommunications device by the use of a security device which comprises:

(i) a first connector connected to the telecommunications device,

(ii) a second connector connected to a telecommunications line,

(iii) a switch having a normally closed position in which a signal pathway within the security device between the first connector and the second connector is enabled and an open position in which the signal pathway is interrupted,

(v) a programmable memory;

(vi) a programmer adapted to program the programmable memory;

the method comprising:

storing at least one authorised pass number in said programmable memory;

providing pass numbers and programming signals, including allowed signal sequences, from a remote telecommunications device via the telecommunications line connected to the second connector to said programmer;

comparing a received pass number with the authorised pass number(s) stored in the memory;

programming the memory with said allowed signal sequences only when an authorised pass number is received;

comparing signals on the pathway with the allowed stored signal sequences; and

opening the switch when a signal on the pathway does not match one of the stored signal sequences.

The telecommunications device which is connected to the security device may be a telephone apparatus, or the modem of a computer.

The security device may further comprise indicator lights (e.g. green and red respectively) adapted to operate when a telecommunications device connected to the first connector is operative and when the switch is opened. The security device may also include an audible warning device adapted to operate when the switch is opened.

The security device may include a battery for powering the security device. The control device may be adapted to open the switch when no operative telecommunications device is connected to the first connector, thereby to save battery power. Alternatively or additionally, the control device may be so programmed to open the switch upon the receipt of an appropriate authorised signal received by the security device, e.g. on the telecommunications line from a remote location.

The security device may further include a clock, in operative connection with the control device, for determining the date, the time of day and elapsed time. The memory may be arranged to store allowed time data and the control device may then be adapted to open the switch in response thereto, e.g. at certain times of day or after certain cumulative time periods.

In a first embodiment of the invention the memory is adapted to store dialling codes, and the control device is adapted to open the switch when a dialling code applied to the pathway does not match one of the stored dialling codes.

In a second embodiment of the invention the control device may be adapted to open the switch when the modem of a computer to which it is connected is connected to an Internet service provider and signal sequences on the pathway do not match one of the stored signal sequences.

The security device may therefore be used for limiting connection to the Internet to preset times of day, and to preset cumulative time limits. Both preset limits can be configured by an authorised end user. To this end, the security device determines active connection to an Internet service, by comparing signals on the pathway when a connection to an Internet service provider is established, with signal sequences stored in the memory of the security device. The security device provides a protected method for setting time limits and a method for disconnection of service during restricted times.

In an embodiment of the invention, the security device according to the invention is a separate unit stored in a lockable housing. The lock of the housing is preferably key operated, and the control device is preferably adapted to open the switch when the lockable housing is unlocked.

The second connector of the unit is ideally in the form of a plug, adapted to co-operate with a wall socket connected to the telecommunications line.

The programmer is connected within the unit to the signal pathway, whereby the memory can be programmed by programming signals applied to the signal pathway, from the remote telecommunications device. Additionally, the unit may further comprise a third connector for connecting the unit to a telephone handset, the third connector being connected within the unit to the programmer, whereby the memory can be programmed by use of the handset, e.g. by the use of dtmf tones.

The security device according to the invention may be modified as necessary to meet local telecommunications apparatus regulations.

In alternative embodiments, the security device according to the invention is incorporated in the same unit as the telecommunications device itself, for example in a land-line telephone apparatus, in a mobile telephone apparatus or in a computer. The incorporation of the security device according to the invention in a mobile telephone provides a useful benefit for parents who purchase mobile telephones for their children but who wish to maintain some control over the extent of their use, and the costs of the calls being made. The security device according to the invention can be programmed by the parent to allow only certain numbers to be dialled, and/or to place time limits on the duration of the calls.

The invention will now be further described, purely by way of example, with reference to the accompanying drawings, in which:

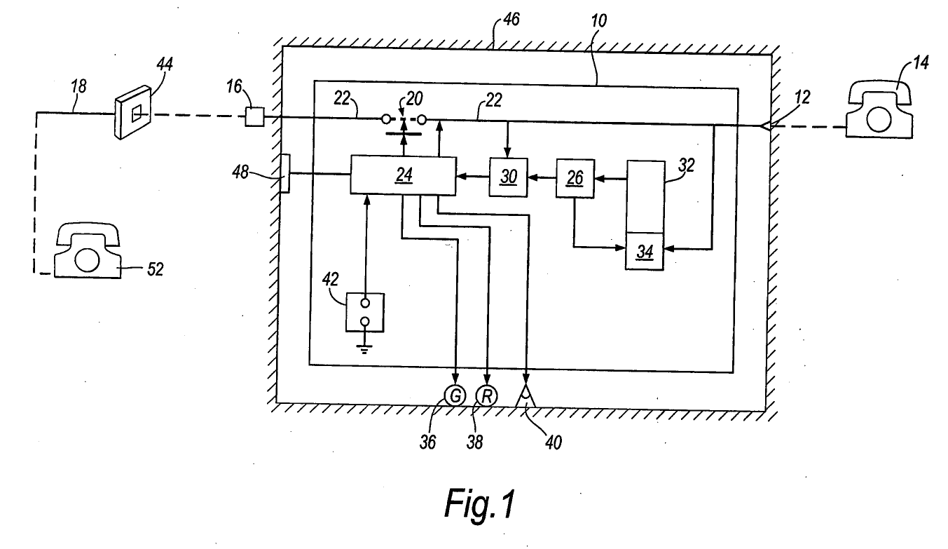

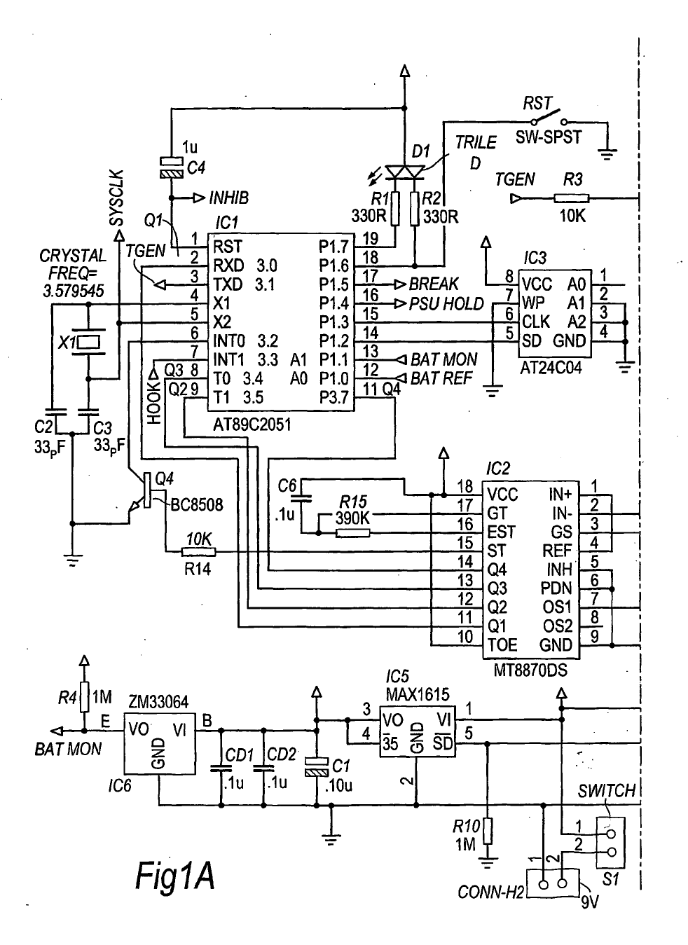

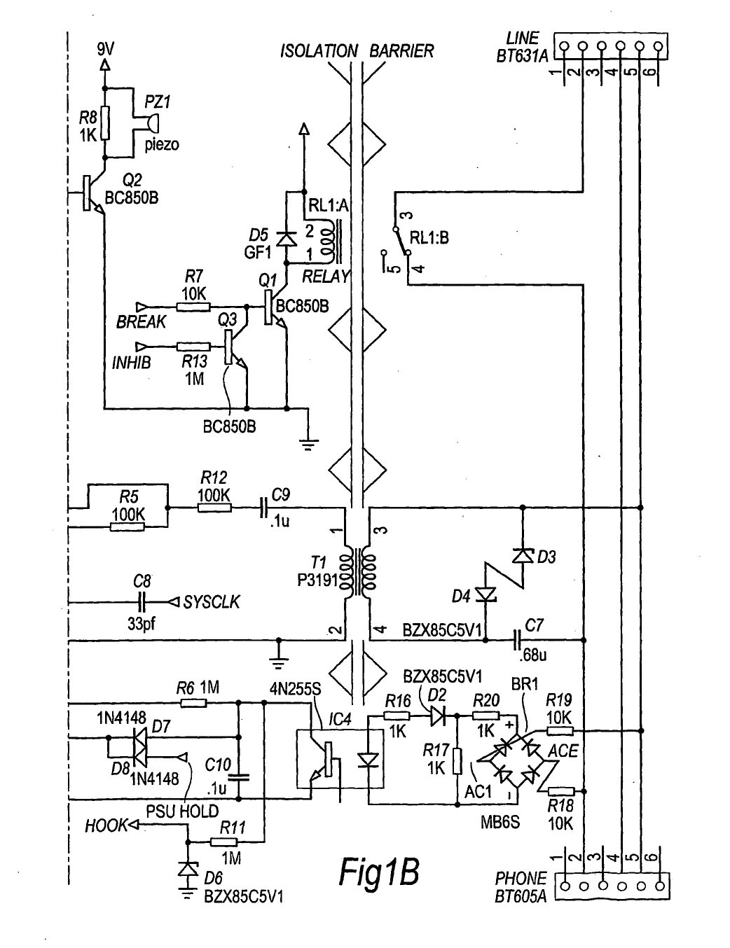

FIG. 1 is a diagrammatic illustration of a first embodiment of the invention for barring calls to preselected numbers;

FIG. 2 is a circuit diagram of the call barring unit shown in FIG. 1; and

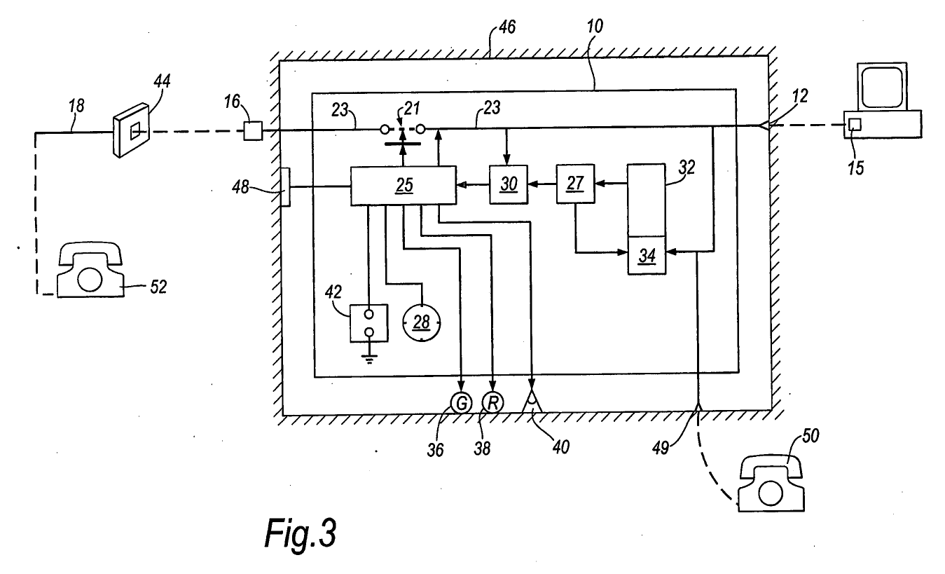

FIG. 3 is a diagrammatic illustration of a first embodiment of the invention for limiting access to the Internet.

FIG. 1 shows a unit 10 having a first connector 12 connected to a telephone apparatus 14. A second connector 16, in the form of a plug, co-operate with a wall socket 44 to connect the unit to a telecommunications line 18.

A normally closed switch 20 within the unit 10 has closed and open positions. In the closed position a signal pathway 22 within the unit 10 between the first connector 12 and the second connector 16 is completed. In the open position the signal pathway 22 is interrupted. The switch 20 is controlled by a control device 24, which is adapted to open the switch 20 when a dialling code applied to the pathway 22 does not match one of the dialling codes stored in a programmable memory 26. The memory 26 may store, for example, ten or twenty authorised dialling codes. The memory 26 also stores at least one authorised pass number.

A comparator 30 is in operative connection with the control device 24 and compares dialling codes applied to pathway 22 from the apparatus 14 with the allowed stored dialling codes in the memory 26. The control device 24 opens the switch 20 when a dialling code on the pathway 22 does not match one of the stored dialling codes.

A programmer 32, adapted to receive pass numbers and programming signals, is connected within the unit 10 to the signal pathway 22. The programmer 32 includes an authorised pass number recognition device 34 for comparing a received pass number with the authorised pass numbers stored in the memory 26, and allows programming of the memory 26 only when an authorised pass number is received. In this manner, the memory 26 can be programmed by programming signals applied to the signal pathway 22.

A green indicator light 36 operates when the apparatus 14 connected to the first connector 12 is taken off-hook.

A red indicator light 38 is lit when the switch 20 is opened, to indicate that the connection has been broken.

An audible warning device 40 also operates when the switch 20 is opened.

A battery 42 is provided for powering the unit 10 and the control device 24 is adapted to open the switch 20 when the apparatus 14 is on-hook, thereby to save battery power.

The unit 10 is stored in a lockable housing 46, the lock 48 of the housing 46 being key operated. The control device 24 opens the switch 20 when the lockable housing 46 is unlocked.

The unit operates as follows. When the receiver of the apparatus 14 is lifted, the green light 36 is illuminated showing an off-hook condition. The user then dials the desired number in the usual way. If the number which is dialled does not match a number stored in the memory 26, the unit opens the switch 20 to disconnect the line. Disconnection is also signalled by a tone from the audible warning device 40 and by illumination of the red light 38 on the unit. The unit is automatically switched off when phone is on-hook, to save battery power.

The unit can be reprogrammed as follows. Firstly, a non-number code such as **** is dialled on the apparatus 14 to trigger the programming mode. To indicate this to the user, the control device 24 applies 2 beeps to the pathway 22 which will be heard by the user on the apparatus 14. The user now enters a pass number e.g. 1234. The recognition device 34 compares this applied pass number with the one or more pass numbers stored in the memory 26. If the pass number matches, programming may continue. To indicate this to the user, the control device 24 again applies 2 beeps to the pathway 22 which will be heard by the user on the apparatus 14. If the pass number is not recognised the unit is shut down. The user may now enter a new authorised number into the memory 26, indicating its position in that memory, and thereby overriding any number previously stored in that position. For example the user may enter 01322 664601#3 and the unit will store the number 01322 664601 in location 3. The unit then shuts down. This programming process can be repeated until all locations of the memory 26 are used.

In addition to the programmable locations of the memory 26, one or more memory locations may be reserved for emergency numbers according to local practice, such as 999 and 911 and these numbers cannot be over-ridden.

The unit may be adapted in such a manner as to allow the user to change the pass number. Also, the unit may be adapted to over-ride the need for a pass number, if for example, the pass number should be forgotten. Thus, for example, if pass number forgotten the user presses an internal reset button, lifts the receiver on the apparatus and keeps holding button for 1 second. When the user next goes into programming mode, any pass number may be entered and this will become a new stored pass number.

The unit 10 can also be programmed remotely from a remote telecommunications device 52 via the telecommunications line 18 by ringing the phone the unit is connected to, having someone answer and then keying in from your remote device 52 as you would for the local phone. The remote telecommunications device 52 may be a land-line or mobile telephone apparatus or a computer modem.

The components used in the circuit shown in FIG. 2 are as detailed in the following table.

TABLE 1

| Type | Qty. | Reference(s) | Value | Specification |
|---|---|---|---|---|
| Resistors | 2 | R1, R2 | 330 R | 1206 |
| | 5 | R3, R7, R14, R18, R19 | 10K | 1206 |
| | 5 | R4, R6, R10, R11, R13 | 1 M | 1206 |
| | 2 | R5, R12 | 100K | 1206 |
| | 4 | R8, R16, R17, R20 | 1K | 1206 |
| | 1 | R15 | 390K | 1206 |
| Capacitors | 1 | C1 | 10μ | TANT-A 6v |
| | 1 | C2 | 22 pf | 1206 |
| | 2 | C3, C8 | 33 pf | 1206 |
| | 1 | C4 | 1μ | TANT-A 6v |
| | 3 | C6, C9, C10 | 0.1μ | 1206 |
| | 1 | C7 | 0.68μ | 160vac |
| Integrated | 1 | IC1 | AT89C2051 | SOIC20 |
| Circuits | 1 | IC2 | MT8870DS | SOIC18 |
| | 1 | IC3 | AT24C04 | |
| | 1 | IC4 | 4N25S | |
| | 1 | IC5 | MAX1615 | |
| | 1 | IC6 | zm33064 | |
| Transistors | 4 | Q1, Q2, Q3, Q4 | BC850B | SOT23 |
| Diodes | 1 | D1 | TRILED | COMMON ANODE |
| | 4 | D2, D3, D4, D6 | BZX85C5V1 | |
| | 1 | D5 | Gf1 | SIGNAL DIODE |
| | 2 | D7, D8 | 1N4148 | |
| Miscellaneous | 1 | 9 V | CONN-H2 | .1*2 HEADER |
| | 1 | BR1 | MB6S | |
| | 2 | CD1, CD2 | 0.1μ | 1206 |
| | 1 | LINE | BT631A | |
| | 1 | PHONE | BT605A | |
| | 1 | PZ1 | piezo | |
| | 1 | RL1 | RELAY | 4.5 V HIGH SENS |
| | 1 | RST | SW-SPST | |
| | 1 | S1 | SWITCH | MICROSWITCH |
| | 1 | T1 | P3191 | P2781 SMD |
| | 1 | X1 | CRYSTAL | 3.579545 MHZ |

In FIG. 2, the switch 20 of FIG. 1 is embodied as the relay RL1, the first connector 12 of FIG. 1 is embodied as the PHONE connector, the memory 26 of FIG. 1 is embodied as the integrated circuit IC3, the second connector 16 of FIG. 1 is embodied as the LINE connector, the control device 24, the comparator 30 and the programmer 32 of FIG. 1 are together embodied as integrated circuit IC1, the recognition device 34 of FIG. 1 is embodied as integrated circuit IC2, the green indicator light 36 and the red indicator light 38 of FIG. 1 are embodied as diode D1, and the audible warning device 40 of FIG. 1 is embodied as piezo device PZ1.

Clearly the security device of the unit described in connection with FIGS. 1 and 2 can be modified to be included in a land-line or mobile telephone apparatus.

The embodiment of FIG. 3 is an in-line, securely fixed, line connection unit having a construction similar to the unit shown in FIG. 1 except as follows.

The telecommunications device connected to the first connector 12 is the modem 15 of a computer.

The control device 25 is adapted to open the switch 21 when the modem is connected to an Internet service provider and signal sequences on the pathway 23 do not match one of the stored signal sequences. Thus the unit acts as a signal detector for valid modem signals.

In this embodiment a clock 28 is provided in operative connection with the control device 25, for determining the date, the time of day and elapsed time.

The memory 27 stores allowed time data and the control device 25 opens the switch 21 in response thereto at certain times of day or after certain cumulative time periods.

In this embodiment a third connector 49 is provided for connecting the unit 10 to a telephone apparatus 50, the third connector 49 being connected within the unit 10 to the programmer 32, so that the memory 27 can be further programmed by dtmf tones generated from the apparatus 50. The telephone apparatus 50 thus acts as a configuration input device for the unit. All configuration data is entered as dtmf tones from the telephone apparatus 50. Access to the configurations will be via a pass number, as described in connection with FIG. 1. In this way, the internal clock, the elapsed time, the allowable time-of-day, and the time per week may be set/reset.

As with the embodiment shown in FIG. 1, the unit will plug into the telephone wall socket, and be locked in place. When the key switch 48 on the unit is opened, this defeats all the unit's features, allowing only the clock 28 to continue running.

1. A telecommunications security device in the form of a separate unit stored in a lockable housing ( 46 ), the device comprising:
(i) a first connector (12) for connection to a telecommunications device (14, 15);
(ii) a second connector (16) for connection to a to telecommunications line (18);
(iii) a switch (20, 21) having a normally closed position in which a signal pathway (22, 23) within the security device between the first connector (12) and the second connector (16) is enabled and an open position in which the signal pathway (22, 23) is interrupted;
(iv) a control device (24, 25) for controlling the position of the switch (20, 21);
(v) a programmable memory (26, 27) for storing allowed signal sequences and at least one authorised pass number;
(vi) a comparator (30) in operative connection with the control device (24, 25) for comparing signals on the pathway (22, 23) with the allowed stored signal sequences, the control device (24, 25) being adapted to open the switch (20, 21) when a signal on the pathway (22, 23) does not match one of the stored signal sequences;
(vii) a programmer (32) adapted to receive pass numbers and programming signals from a remote telecommunications device (52) via a telecommunications line connected to the second connector (16), the programmer (32) including an authorised pass number recognition device (34) for comparing a received pass number with the authorised pass numbers stored in the memory (26, 27), and being adapted to program the memory (26, 27) only when an authorised pass number is received and
(viii) a battery (42) for powering the security device, wherein the control device (24, 25) is adapted to open the switch (20, 21) when no operative telecommunications device (14, 15) is connected to the first connector (12), thereby to save battery power;

2. A telecommunications security device according to claim 1, wherein the lock (48) of the housing (46) is key is operated.

3. A telecommunications security device according to claim 1 or 2, wherein the control device (24, 25) is adapted to open the switch (20, 21) when the lockable housing (46) is unlocked.

4. A telecommunications security device according to any preceding claim, wherein the telecommunications device (15) is the modem of a computer, wherein the control device (25) is adapted to open the switch (21) when the modem is connected to an Internet service provider and signal sequences on the pathway (23) do not match one of the stored signal sequences.

5. A telecommunications security device according to any preceding claim, further comprising a third connector (49) for connecting the security device to a telephone handset (50), the third connector (49) being connected within the security device to the programmer (32), whereby the memory (26) can be further programmed by use of the handset (50).

6. A method of controlling a telecommunications device by the use of a security device in the form of a separate unit so stored in a lockable housing (46), which device comprises:
(i) a first connector (12) connected to the telecommunications device (14, 15),
(ii) a second connector (16) connected to a telecommunications line (18),
(iii) a switch (20, 21) having a normally closed position in which a signal pathway (22, 23) within the security device between the first connector (12) and the second connector (16) is enabled and an open position in which the signal pathway (22, 23) is interrupted,
(v) a programmable memory (26, 27);
(vi) a programmer (32) adapted to program the programmable memory (26, 27); and
(vii) a battery (42) for powering the security device;
the method comprising:
storing at least one authorised pass number in said programmable memory (26, 27);
providing pass numbers and programming signals, including allowed signal sequences, from a remote telecommunications device (52) via the telecommunications line connected to the second connector to said programmer (32);
comparing a received pass number with the authorised pass number(s) stored in the memory (26, 27);
programming the memory (26, 27) with said allowed signal sequences only when an authorised pass number is received;
comparing signals on the pathway (22, 23) with the allowed stored signal sequences;
opening the switch (20, 21) when a signal on the pathway (22, 23) does not match one of the stored signal sequences; and
opening the switch (20, 21) when no operative telecommunications device (14, 15) is connected to the first connector (12), thereby to save battery power.

7. A method according to claim 6, wherein the switch (20, 21) is opened when the lockable housing (46) is unlocked.

8. A method according to claim 6 or 7, wherein the security device further comprises a third connector (49) for connecting the security device to a telephone handset (50), the third connector (49) being connected within the security device to the programmer (32), the method comprising further programming the memory (26) by use of the handset (50).

9. A method according to any one of claims 6 to 8, wherein the telecommunications device (15) is the modem of a computer, and the method comprises opening the switch (21) when the modem is connected to an Internet service provider and signal sequences on the pathway (23) do not match one of the stored signal sequences.
